(19) United States
(12) Patent Application Publication
(10) Pub. No.: US 2023/0327605 A1
(43) Pub. Date: Oct. 12, 2023

(54) PHOTOVOLTAIC JUNCTION BOX

(71) Applicant: Luxshare Precision Industry(Chuzhou), Ltd., Chuzhou (CN)

(72) Inventors: YueSheng LIU, Chuzhou (CN); ZhangJun FEI, Chuzhou (CN); Shun WANG, Chuzhou (CN); GuangMing YE, Chuzhou (CN)

(73) Assignee: Luxshare Precision Industry(Chuzhou), Ltd., Chuzhou (CN)

(21) Appl. No.: 18/132,197

(22) Filed: Apr. 7, 2023

(30) Foreign Application Priority Data
Apr. 8, 2022 (CN) 202210365976.3

(51) Int. Cl. H02S 40/34; H02G 3/08

(52) U.S. Cl. CPC H02S 40/34; H02G 3/083

(57) ABSTRACT

A photovoltaic junction box includes a box body, an electrical assembly and a fixing member is provided. The box body having an accommodating portion and a fixing portion; the accommodating portion includes an accommodating cavity; the fixing portion includes a fixing groove, a first wire groove, a first concave groove and a first fixing column; the accommodating groove and the fixing grooves communicate with each other, the electrical assembly is arranged in the accommodating cavity; the fixing member engages with the fixing groove; the first wire groove corresponds to the second wire groove. One end of the cable is connected to the electrical assembly through the first wire groove and the second wire groove, and the first fixing column and the second fixing column are against the surface of the cable.

### CROSS-REFERENCE TO RELATED DISCLOSURE

This disclosure claims the priority benefit of Chinese Patent Disclosure Serial Number 202210365976.3, filed on Apr. 8, 2022, the full disclosure of which is incorporated herein by reference.

### BACKGROUND

### Technical Field

The present disclosure relates to the technical field of photovoltaic junction boxes, in particularly to photovoltaic junction boxes that prevents cable from dropping off.

### Related Art

In the prior art, along with the development of mankind, the global environment and energy have become the primary problems of mankind. The active development and use of green and renewable energy has become the focus of our current development. The photovoltaic module junction box is a connection device between the solar cell array formed by the solar cell module and the solar charging control device. The main function of photovoltaic module junction box is to connect and protect solar photovoltaic modules, connect the power generated by solar cells with external lines, and conduct the current generated by photovoltaic modules. During the assembly process of the photovoltaic system, the photovoltaic junction box needs to have a good anti-loosening and anti-rotation function to prevent the cables connected to the photovoltaic junction box from falling off.

### SUMMARY

The embodiment of the disclosure provides a photovoltaic junction box to solves the connection strength between present photovoltaic junction box and cable, avoiding the problem that the cables are detached from the photovoltaic junction box due to accidental shaking or pulling by external forces.

A photovoltaic junction box comprising a box body, an electrical assembly and a fixing member is provided. The box body having an accommodating portion and a fixing portion; the accommodating portion includes an accommodating cavity; the fixing portion includes a fixing groove, a first wire groove, a first concave groove and a first fixing column; the accommodating groove and the fixing grooves communicate with each other; the first wire groove is arranged at the bottom of the fixing groove; the first groove is arranged at the bottom of the first wire groove; the first fixing column is arranged at the bottom of the first concave groove; one end of the first fixing column protrudes from the bottom of the first wire groove; the electrical assembly is arranged in the accommodating cavity; the electrical assembly includes a first electrode, a second electrode and a diode; the first electrode and the second electrode correspondingly connects to the two ends of the diode; the first electrode corresponds to one side of the fixing groove; the fixing member includes a second wire groove, a second concave groove and a second fixing column; the second concave groove is arranged at the bottom of the second wire groove; the second fixing column is arranged at the bottom of the second concave groove; one end of the second fixing column protrudes from the bottom of the second wire groove; the fixing member engages with the fixing groove; the first wire groove corresponds to the second wire groove.

In one of the embodiment, the photovoltaic junction box further comprises a cable; one end of the cable passes through the first wire groove and the second wire groove and is connected to the first electrode; the first fixing column abuts against the first surface of the cable; the portion around the first surface of the cable is pressed into the first concave groove; the second fixing column abuts against the second surface of the cable; the portion around the second surface of the cable is pressed into the second groove.

In one of the embodiment, the first concave groove and the second concave groove are filled with fixing glue; the portion around the first surface of the cable pressed into the first concave groove is fixed with the fixing glue; the portion around the second surface of the cable is pressed into the second groove is fixed with the fixing glue.

In one of the embodiment, the fixing portion comprises a first fixing block; the first fixing block is arranged on the bottom of the first wire groove; the fixing member comprises a second fixing block; the second fixing block is arranged on the bottom of the second wire groove.

In one of the embodiment, the first fixing block is arranged along the direction perpendicular to the groove extension direction of the first wire groove; the second fixing block is arranged along the direction perpendicular to the groove extension direction of the second wire groove.

In one of the embodiment, there are a plurality of first fixing blocks; the plurality of the first fixing blocks are arranged on the bottom of the first wire groove; there are a plurality of second fixing blocks, the plurality of the second fixing blocks are arranged on the bottom of the second wire groove.

In one of the embodiment, the fixing member has a plurality of connecting blocks; the plurality of the connecting blocks are arranged around the notch of the second groove; the fixing member is engaged with the fixing groove; the plurality of the connecting blocks are connected and fixed on the bottom of the fixing groove.

In one of the embodiment, the fixing member comprises a plurality of connecting blocks; the plurality of the connecting blocks are arranged around the notch of the second groove; the fixing member is engaged with the fixing groove; the plurality of the connecting blocks are connected and fixed on the bottom of the fixing groove.

In one of the embodiment, the first electrode comprises a concave portion corresponding to one side of the fixing groove; one end of the cable is connected and fixed through the concave portion of the first electrode.

In one of the embodiment, the surface of the recess comprises a rib.

In one of the embodiment, the accommodating portion comprises a base and a top cover; the base comprises the accommodating cavity; the top cover covers the accommodating cavity; the base comprises a first connecting structure; the top cover comprises a second connecting structure; the first connecting structure and the second connecting structure are combined with each other.

In one of the embodiment, the first connecting structure further has a first guiding portion; the second connecting structure further has a second guiding portion, and the first guiding portion and the second guiding portion are guided and combined with each other.

In one of the embodiment, the first connecting structure further has a first fastening portion; the second connecting structure further has a second fastening portion; the first fastening portion and the second fastening portion are snapped with each other.

In one of the embodiment, the first electrode comprises a first connection groove; the second electrode comprises a second connection groove; the base comprises a perforation corresponding to the first connection groove and the second connection groove.

In one of the embodiment, the base comprises a guide member; the guide member is located in the t perforation; the two ends of the guide member respectively correspond to the first connection groove and the second connection groove.

In one of the embodiment, the box body further comprises a fixing rib disposed on the outer surface of the fixing portion.

In summary, the disclosure provides a photovoltaic junction box, in which the cable is passed through the fixing portion of box body first, and then the fixing member is embedded in fixing portion for fixing. In this way, the fixing portion and the fixing member clamp and fix the cable. A groove is formed between the fixing portion and the fixing member. The fixing column is arranged at the bottom of the groove. The fixing column squeezes the surface on the outside of the cable. The periphery of the extruded surface is extruded into the groove. The cable is fixed between the fixing portion and the fixing member in this way, so as to prevent the cable from being accidentally shaken or pulled by an external force, resulting in that the cable detach from the photovoltaic junction box.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is the perspective view of the first embodiment of the photovoltaic junction box of the present disclosure;

FIG. 2 is the exploded view of the first embodiment of the photovoltaic junction box of the present disclosure:

FIG. 3 is another exploded view of the first embodiment of the photovoltaic junction box of the present disclosure;

FIG. 4 is the assembled exploded view of the first embodiment of the photovoltaic junction box of the present disclosure:

FIG. 5 is the sectional view of A-A′ line of FIG. 1:

FIG. 6 is the sectional view of the B-B′ line of FIG. 1;

FIG. 7 is the assembled exploded view of the second embodiment of the photovoltaic junction box of the present disclosure; and

FIG. 8 is the assembled exploded view of the third embodiment of the photovoltaic junction box of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

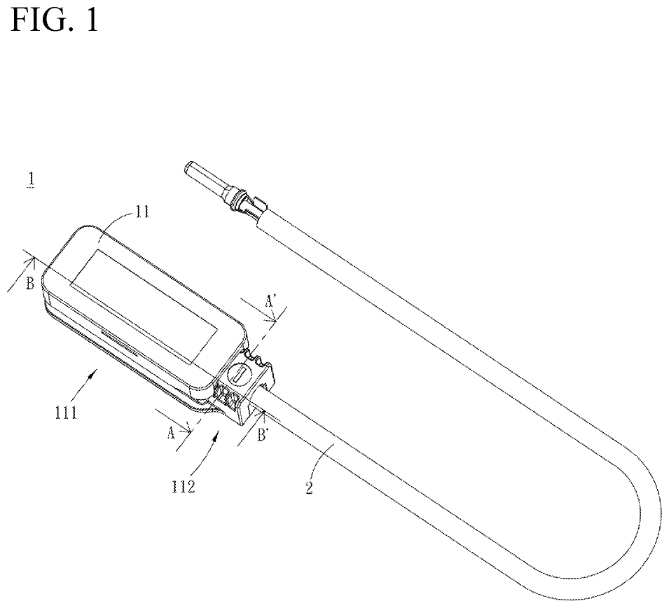

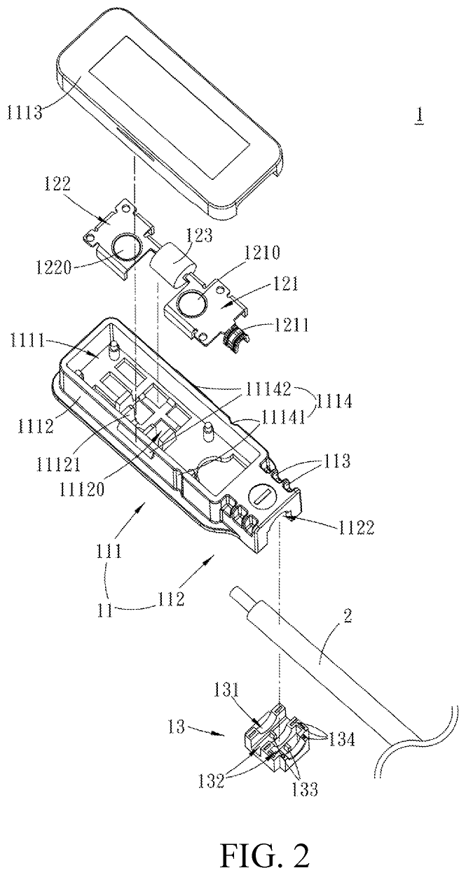

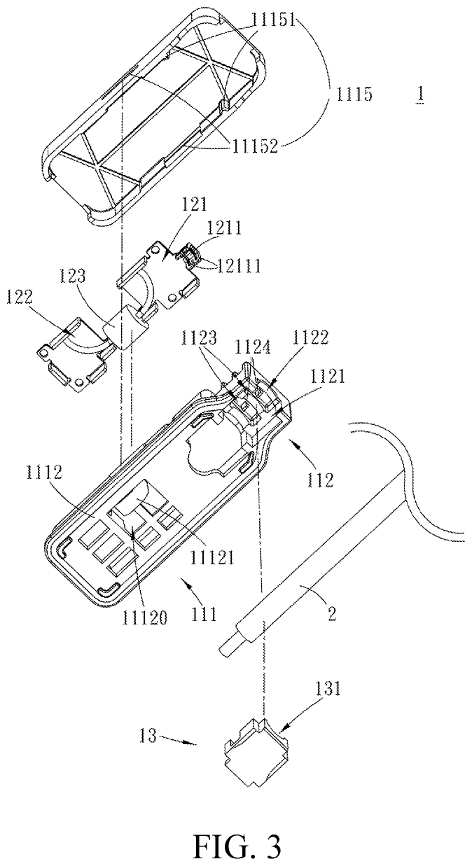

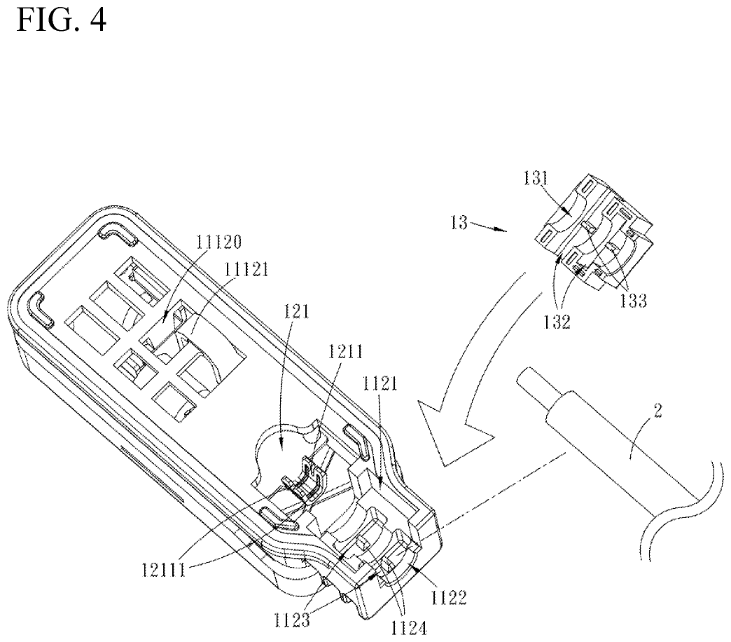

Refer to FIG. 1 to FIG. 4. FIG. 1 is the perspective view of the first embodiment of the photovoltaic junction box of the present disclosure. FIG. 2 is the exploded view. FIG. 3 is another exploded view. FIG. 4 is the assembled exploded view. As shown in the figure, the present disclosure provides a photovoltaic junction box 1, which includes: a box body 11, an electrical assembly 12 and a fixing member. 13. The box body 11 has an accommodating portion 111 and a fixing portion 112.

The accommodating portion 111 has an accommodating cavity 1111. The fixing portion 112 has a fixing groove 1121, a first wire groove 1122, a first concave groove 1123 and a first fixing column 1124. The accommodating cavity 1111 communicates with the fixing groove 1121. The first wire groove 1122 is arranged at the groove bottom of the fixing groove 1121. The first groove 1123 is disposed at the bottom of the first wire groove 1122. The first fixing column 1124 is disposed in the first groove 1123. One end of the first fixing column 1124 protrudes from the bottom of the first wire groove 1122. The electrical assembly 12 is disposed in the accommodating cavity 1111. The electrical assembly 12 includes a first electrode 121, a second electrode 122 and a diode 123. The first electrode 121 and the second electrode 122 are correspondingly connected to both ends of the diode 123. One side of the first electrode 121 corresponding to one side of the fixing groove 1121. The fixing member 13 has a second wire groove 131, a second concave groove 132 and a second fixing column 133. The second concave groove 132 is arranged at the bottom of the second wire groove 131; the second fixing column 133 is arranged at the bottom of the second concave groove 132; one end of the second fixing column 133 protrudes from the bottom of the second wire groove 131; the fixing member 13 engages with the fixing groove 1121; the first wire groove 1122 corresponds to the second wire groove 131.

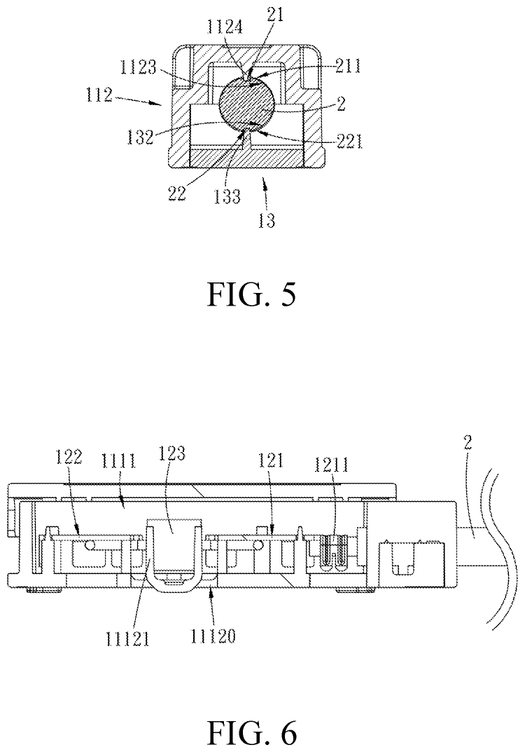

Refer to FIG. 5 to FIG. 6. FIG. 5 is a sectional view along line A-A′ of FIG. 1 and FIG. 6 is a sectional view along line B-B′ of FIG. 1. As shown in the figure, the user connects one end of the cable 2 to the first electrode 121 through the first second wire groove 1122 and the second wire groove 131. The first fixing post 1124 abuts against the first surface 21 of the cable 2. The portion 211 around the first surface 21 of the cable 2 is pressed into the first concave groove 1123. The second fixing column 133 abuts against the second surface 22 of the cable 2. The portion 221 around the second surface 22 of the cable 2 is pressed into the second groove 132. The outer diameter of the cable 2 is between 6.1 mm and 6.4 mm.

In this embodiment, the first fixing column 1124 and the second fixing column 133 are further embedded in the surface of the cable 2 by ultrasonic waves. The portion 211 around the surface of the cable 2 pressed by the first fixing column 1124 is also partially embedded in the first groove 1123. The portion 221 around the surface of the cable 2 pressed by the second fixing column 133 is also partially embedded in the second groove 132 at the same time. In this way, the cable 2 detached or randomly rotated between the first wire slot 1122 and the second wire slot 131 is avoided.

Based on the above, it is further possible to fill the first groove 1123 and the second groove 132 with fixing glue. The cable surface 211 of the cable 2 pressed into the first concave groove 1123 is fixed with the fixing glue. The cable surface 221 of the cable 2 is pressed into the second groove 132 is fixed with the fixing glue. In this way, the combination strength of the cable 2 combined with the fixing portion 112 and the fixing member 13 is enhanced.

Furthermore, the fixing member 13 has a plurality of connection blocks 134, and the plurality of connection blocks 134 are arranged around the notch of the second wire groove 131. The fixing part 13 engages with the fixing groove 1121. The connection block 134 is connected and fixed on the bottom of the fixing groove 1121.

The fixing member 13 further welds and fixes the connection block 134 and the second slot 131 by ultrasonic waves. In this way, the bonding strength of the fixing part 13 embedded in the fixing part 112 of the box body 11 is strengthened, and the cables 2 passing through between the first wire groove 1122 and the second wire groove 131 are strengthened and fixed. In addition, the box body 11 further includes fixing ribs 113. The fixing ribs 113 are disposed on the outer surface of the fixing portion 112. The fixing ribs 113 are used to strengthen the structural strength of the fixing groove 1121. This can prevent the fixing portion 112 from being deformed after the fixing part 13 is embedded in the fixing portion 112, resulting in the fixing portion 13 easily to fall off from the fixing portion 112.

Refer to FIG. 4. In this embodiment, the first electrode 121 has a concave portion 1211. The concave portion 1211 corresponds to one side of the fixing groove 1121. One end of the cable 2 is fixed through the concave portion 1211 of the first electrode 121. The concave portion 1211 is a structure that can be deformed by sheet metal. The concave portion 1211 is formed by bending one end of the first electrode 121 close to the fixing groove 1121 toward both sides of the cable 2 into a U-shaped structure. The cable 2 is fixed in the concave portion 1211 of the first electrode 121. The surface of the concave portion 1211 has ribs 12111, which can strengthen the structural strength of the concave portion 1211.

The accommodating portion 111 includes abase 1112 and a top cover 1113. The base 1112 has an accommodating cavity 1111. The top cover 1113 covers the accommodating cavity 1111. The base 1112 has a first connection structure 1114. The top cover 1113 has a second connection structure 1115. The first connection structure 1114 and the second connection structure 1115 are combined to cover the top cover 1113 on the base 1112 to cover the accommodating cavity 1111. The first connecting structure 1114 further has a first guiding portion 11141 and a first fastening portion 11142. The second connecting structure 1115 further has a second guiding portion 11151 and a second fastening portion 11152. The first guiding portion 11141 and the second guiding portion 11151 combine with each other, which are used to guide the installation direction of the base 1112 and the top cover 1113. In this way, the wrong assembly direction of the base 1112 and the top cover 1113 can be avoided. The first fastening portion 11142 and the second fastening portion 11152 are buckled together, and are used for fastening and fixing the base 1112 and the top cover 1113 to each other.

The first electrode 121 has a first connection groove 1210. The second electrode 122 has a second connection groove 1220. The base 1112 has a perforation 11120. The perforation 11120 corresponds to the first connection groove 1210 and the second connection groove 1220. Furthermore, the base 1112 has a guide member 11121, and the guide member 11121 is located in the perforation 11120. Both ends of the guide member 11121 correspond to the first connection groove 1210 and the second connection groove 1220 respectively. The guide member 11121 is a U-shaped structure. The bus moves to the first connection groove 1210 and the second connection groove 1220 along the guide member 11121 of the base 1112 of the box body 11. In this way, the guide member 11121 can quickly and effectively align the and guide of the bus and prevent the bus from falling in the opposite direction, and at the same time avoid welding errors caused by the bus falling in the opposite direction. Then the bus is welded to the first connection groove 1210 and the second connection groove 1220. The grooves of the first connecting groove 1210 and the second connecting groove 1220 are used for accommodating the tin liquid of the solder. In addition, the diode 123 is used to connect the first electrode 121 and the second electrode 122. The main function of the diode 123 is a one-way conduction, and the diode 123 can be an anti-recoil diode. When the photovoltaic junction box 1 has no current flowing to the charging energy, it prevents the battery current from flowing backwards.

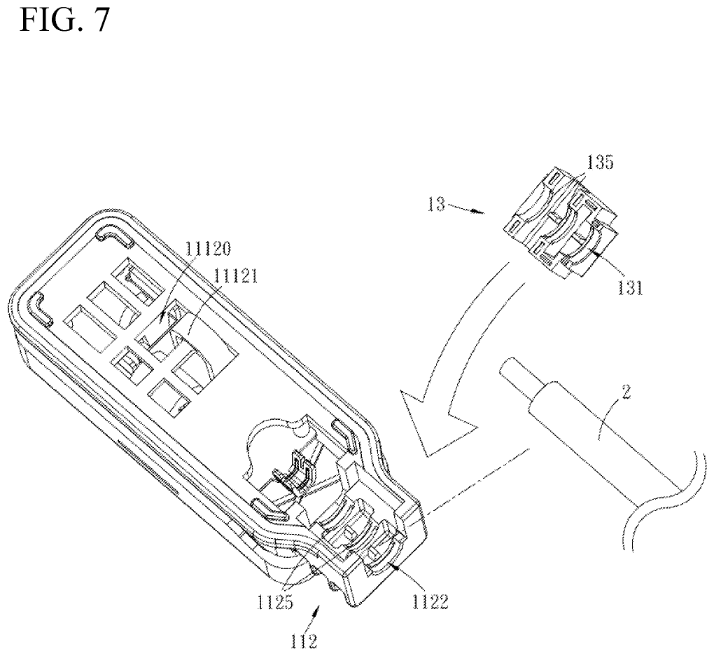

Refer to FIG. 7 showing the assembled exploded view of the second embodiment of the photovoltaic junction box of the present disclosure. As shown in the figure, the difference between this embodiment and the first embodiment lies in the first fixing block 1125 and the second fixing block 135. In this embodiment, the fixing portion 112 has a first fixing block 1125, and the first fixing block 1125 is arranged on the bottom of the first wire groove 1122. The first fixing block 1125 is arranged along the groove extending direction perpendicular to the first wire groove 1122. At the same time, the first fixing block 1125 is also arranged along the curved surface of the wall of the first groove 1122. The fixing member 13 has a second fixing block 135, and the second fixing block 135 is arranged on the bottom of the second wire groove 131. The second fixing block 135 is arranged along the groove extending direction perpendicular to the second wire groove 131. At the same time, the second fixing block 135 is also arranged along the curved surface of the wall of the second wire groove 131. In this way, when the cable 2 passes through the first wire groove 1122 and the second wire groove 131, the surface of the cable 2 is pressed by the first fixing block 1125 and the second fixing block 135, and the first fixing block 1125 and the second fixing block 135. Further, the first fixing block 1125 and the second fixing block 135 are embedded in the surface of the cable 2 by ultrasonic waves. In this way, the phenomenon that the cable 2 is detached or randomly rotated between the first wire slot 1122 and the second wire slot 131 can be avoided.

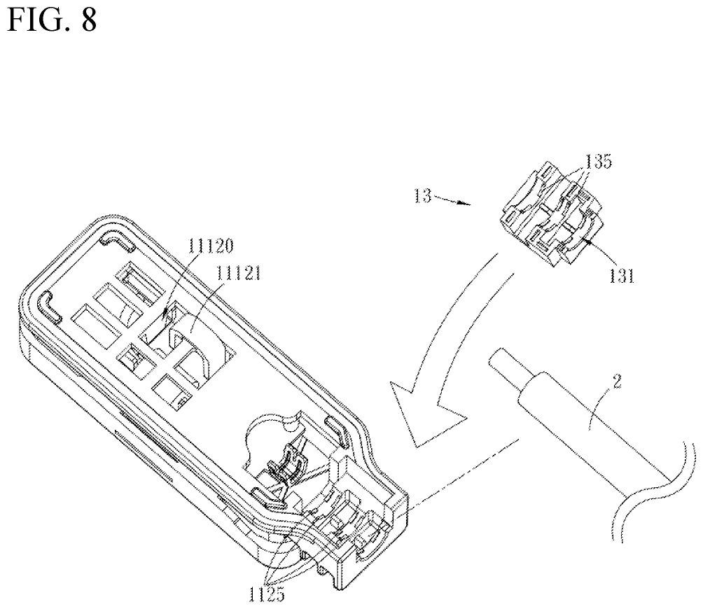

Refer to FIG. 8 showing the assembled exploded view of the third embodiment of the photovoltaic junction box of the present disclosure. As shown in the figure, the difference between this embodiment and the second embodiment lies in the arrangement of the first fixing block 1125 and the second fixing block 135. In this embodiment, there are multiple first fixing blocks 1125, and the multiple first fixing blocks 1125 are arranged at the bottom of the first wire groove 1122. There are also multiple second fixing blocks 135, and the multiple second fixing blocks 135 arranged at the bottom of the second wire slot 131. The plurality of first fixing blocks 1125 are arranged along the extending direction of the groove perpendicular to the first wire groove 1122. The plurality of second fixing blocks 135 are arranged along a direction perpendicular to the extending direction of the second wire groove 131. In this embodiment, the plurality of first fixing blocks 1125 and the plurality of second fixing blocks 135 are embedded on the surface of the cable 2 through ultrasonic waves. In this way, the situation that the cable 2 is detached or arbitrarily rotated between the first wire slot 1122 and the second wire slot 131 can be avoided.

In summary, the disclosure provides a photovoltaic junction box, in which the cable is passed through the fixing portion of box body first, and then the fixing member is embedded in fixing portion for fixing. In this way, the fixing portion and the fixing member clamp and fix the cable. A groove is formed between the fixing portion and the fixing member. The fixing column is arranged at the bottom of the groove. The fixing column squeezes the surface on the outside of the cable. The periphery of the extruded surface is extruded into the groove. The cable is fixed between the fixing portion and the fixing member in this way, so as to prevent the cable from being accidentally shaken or pulled by an external force, resulting in that the cable detach from the photovoltaic junction box.

It is to be understood that the term “comprises”, “comprising”, or any other variants thereof, is intended to encompass a non-exclusive inclusion, such that a process, method, article, or device of a series of elements not only comprise those elements but further comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A photovoltaic junction box, comprising:
a box body having an accommodating portion and a fixing portion; the accommodating portion having an accommodating cavity; the fixing portion having a fixing groove, a first wire groove, a first concave groove and a first fixing column; the accommodating groove and the fixing grooves communicating with each other; the first wire groove arranged at the bottom of the fixing groove; the first groove arranged at the bottom of the first wire groove; the first fixing column arranged at the bottom of the first concave groove; one end of the first fixing column protruding from the bottom of the first wire groove;
an electrical assembly, arranged in the accommodating cavity, the electrical assembly comprising a first electrode, a second electrode and a diode; the first electrode and the second electrode correspondingly connected to the two ends of the diode; the first electrode corresponding to one side of the fixing groove; and
a fixing member having a second wire groove, a second concave groove and a second fixing column; the second concave groove arranged at the bottom of the second wire groove; the second fixing column arranged at the bottom of the second concave groove; one end of the second fixing column protruding from the bottom of the second wire groove; the fixing member engaging with the fixing groove; the first wire groove corresponding to the second wire groove.

2. The photovoltaic junction box according to claim 1, further comprises a cable; one end of the cable passes through the first wire groove and the second wire groove and is connected to the first electrode; the first fixing column abuts against the first surface of the cable; the portion around the first surface of the cable is pressed into the first concave groove; the second fixing column abuts against the second surface of the cable; the portion around the second surface of the cable is pressed into the second groove.

3. The photovoltaic junction box according to claim 2, wherein the first concave groove and the second concave groove are filled with fixing glue; the portion around the first surface of the cable pressed into the first concave groove is fixed with the fixing glue; the portion around the second surface of the cable is pressed into the second groove is fixed with the fixing glue.

4. The photovoltaic junction box according to claim 1, wherein the fixing portion comprises a first fixing block; the first fixing block is arranged on the bottom of the first wire groove; the fixing member comprises a second fixing block; the second fixing block is arranged on the bottom of the second wire groove.

5. The photovoltaic junction box according to claim 4, wherein the first fixing block is arranged along the direction perpendicular to the groove extension direction of the first wire groove; the second fixing block is arranged along the direction perpendicular to the groove extension direction of the second wire groove.

6. The photovoltaic junction box according to claim 4, wherein there are a plurality of first fixing blocks; the plurality of the first fixing blocks are arranged on the bottom of the first wire groove; there are a plurality of second fixing blocks; the plurality of the second fixing blocks are arranged on the bottom of the second wire groove.

7. The photovoltaic junction box according to claim 1, wherein the fixing member comprises a plurality of connecting blocks; the plurality of the connecting blocks are arranged around the notch of the second groove; the fixing member is engaged with the fixing groove; the plurality of the connecting blocks are connected and fixed on the bottom of the fixing groove.

8. The photovoltaic junction box according to claim 2, wherein the first electrode comprises a concave portion corresponding to one side of the fixing groove; one end of the cable is connected and fixed through the concave portion of the first electrode.

9. The photovoltaic junction box according to claim 2, wherein the surface of the recess comprises a rib.

10. The photovoltaic junction box according to claim 1, wherein the accommodating portion comprises a base and a top cover; the base comprises the accommodating cavity; the top cover covers the accommodating cavity; the base comprises a first connecting structure; the top cover comprises a second connecting structure; the first connecting structure and the second connecting structure are combined with each other.

11. The photovoltaic junction box according to claim 10, wherein the first connecting structure further has a first guiding portion; the second connecting structure further has a second guiding portion, and the first guiding portion and the second guiding portion are guided and combined with each other.

12. The photovoltaic junction box according to claim 10, wherein the first connecting structure further has a first fastening portion; the second connecting structure further has a second fastening portion; the first fastening portion and the second fastening portion are snapped with each other.

13. The photovoltaic junction box according to claim 10, wherein the first electrode comprises a first connection groove; the second electrode comprises a second connection groove; the base comprises a perforation corresponding to the first connection groove and the second connection groove.

14. The photovoltaic junction box according to claim 13, wherein the base comprises a guide member; the guide member is located in the t perforation: the two ends of the guide member respectively correspond to the first connection groove and the second connection groove.

15. The photovoltaic junction box according to claim 1, wherein the box body further comprises a fixing rib disposed on the outer surface of the fixing portion.
